(19) United States
(12) Patent Application Publication
(10) Pub. No.: US 2024/0046760 A1
(43) Pub. Date: Feb. 8, 2024

(54) PROGRESSIVE POKER JACKPOT SYSTEM

(71) Applicant: EMPIRE TECHNOLOGICAL GROUP LIMITED, Las Vegas, NV (US)

(72) Inventors: Linyi FENG, Las Vegas, NV (US); Garrett Matthew OLSON, Reno, NV (US); William Christandi LOE, Las Vegas, NV (US); Daryn KIELY, Henderson, NV (US); Jeff E. HARRIS, Chino Hills, CA (US)

(21) Appl. No.: 17/882,467

(22) Filed: Aug. 5, 2022

(51) Int. Cl. G07F 17/32

(52) U.S. Cl. CPC G07F 17/3258; G07F 17/3293

(57) ABSTRACT

A system for determining and awarding a monetary reward including an electronic gaming table having a gaming table control system, a server electronically connected to the gaming table, a plurality of betting stations connected to the gaming table control system and configured to allow a player to place a jackpot wager to win the monetary reward, wherein the gaming table control system is configured to add at least a portion of the jackpot wager to the monetary award, a plurality of playing cards such that certain combinations of the playing cards result in a winning hand that captures the monetary award, and a dealer terminal being configured to communicate to the server that a winning hand has occurred, wherein the server is configured to add at least a portion of the monetary reward to a player's betting account when a winning hand occurs.

### BACKGROUND

Over the last several decades, poker has become a popular casino game, both for land-based and online virtual gaming establishments. In a typical poker game, players play against each other and wager on their hands in an attempt to win the pot built during game play of that hand. However, if a system could provide an additional aspect to the poker game in terms of the ability to win a jackpot award that accumulates over many tables spaced through a number of gaming establishments in a larger geographic area than a single table or a single casino, players would have an additional chance to win a prize on each hand which would add excitement and intrigue to the game.

### SUMMARY

Embodiments of the present invention are directed to a system for determining and awarding a monetary reward including a plurality of electronic gaming tables, each gaming table being configured to be connected to a network and being configured to allow the playing of an underlying game, each gaming table having a gaming table control system, a central computer electronically connected to each of the gaming tables and configured to maintain an amount of a balance of the monetary reward, a progressive system server connected to each of the gaming tables and to the central computer to relay information between the central computer and the respective gaming table, a plurality of betting stations connected to the gaming table control system, each of the betting stations configured to allow a player to draw funds from a betting account and to place a jackpot wager to participate in an opportunity to win the monetary reward based on funds in the betting account, wherein at least a portion of the jackpot wager is contributed to the monetary award, wherein the monetary reward is separate from any award that can be won in the underlying game, and wherein the gaming table control system is configured to communicate with the server to add at least a portion of the jackpot wager to the monetary award maintained by the central computer, a plurality of playing cards each having a designated value, wherein the playing cards are configured to be used for the underlying game and wherein a plurality of the playing cards are configured to be placed on the gaming table such that the designated value of the playing card may be exposed and such that certain combinations of the designated values of the playing cards result in a winning hand that captures the monetary award, and a dealer terminal connected to the gaming table control system, the dealer terminal being configured to communicate to the server that a winning hand has occurred, wherein the progressive system server is configured to communicate to the gaming table control system to add at least a portion of the monetary reward to a player's betting account when the player has placed a jackpot wager and when the dealer terminal communicates to the server that the winning hand has occurred.

In one embodiment, the gaming tables are located in at least two different gaming establishments. Further, the dealer terminal may be configured to allow a user to provide the ability to the player to participate in the opportunity to win the monetary reward and is configured to allow a user to prevent the player from participating in the opportunity to win the monetary reward. Additionally, a plurality of betting stations may be located on each gaming table and wherein each of the betting stations has a touch screen or a button to allow a player to make the jackpot wager.

In one embodiment, the system further includes a display device connected to the gaming table control system, wherein the display device is configured to display the monetary reward amount and to update the amount of the monetary award as the amount of the monetary award changes. Further, the progressive system server may be configured to be able to identify the gaming tables and is configured to allow or deny access of each of the gaming tables to join the system.

In one embodiment, the gaming table control system includes a gaming table controller, the gaming table controller comprising a dealer terminal interface to interface between the gaming table controller and the dealer terminal. Additionally, in one embodiment, for each jackpot wager placed, a certain amount of the jackpot wager may be contributed to the monetary award and a certain amount of the jackpot wager may be contributed to a reserve monetary that may be distributed when a balance of the monetary award is not enough to award players when a winning hand is made.

Further, in one embodiment, when the dealer terminal communicates to the progressive system server that a winning hand has occurred, the progressive system server is configured to award the monetary reward to each player at the gaming table that has made a jackpot wager.

In another embodiment, a method for determining and awarding a monetary reward is provided including connecting a plurality of electronic gaming tables to a network such that an underlying game can be played at each of the gaming tables and such that game information from each table can be shared with the network, each gaming table having a gaming table control system configured to electronically connect the gaming tables to a central computer that is configured to maintain an amount of a balance of the monetary reward, electronically connect the gaming table to a server, the server configured to maintain an amount of a balance of the monetary reward, receive via one of a plurality of betting stations connected to the gaming table control system a player contribution to funds for a betting account and a jackpot wager from the player based on funds in the betting account to participate in an opportunity to win the monetary reward, wherein the monetary reward is separate from any award that can be won in the underlying game, communicate with the server to add at least a portion of the jackpot wager to the monetary award maintained by the server, receive via a dealer terminal input regarding a winning hand made by a plurality of playing cards having a designated value, such designated value being exposed on the gaming table, and add at least a portion of the monetary reward to a player's betting account when the player has placed a jackpot wager and upon notification from the server that a winning hand has occurred.

### BRIEF DESCRIPTION OF THE DRAWINGS

FIG. 1 is a perspective view of a gaming table for a progressive poker jackpot system according to one embodiment.

FIG. 2 is a top view of the gaming table of FIG. 1.

FIG. 3 is a perspective view of an embodiment of a progressive poker jackpot system.

FIG. 4A is a top view of an embodiment of a betting station of the progressive poker jackpot system.

FIGS. 4B and 4C are views of a betting station screen according to one embodiment of a betting station of the progressive poker jackpot system.

FIG. 5A is a perspective view of an embodiment of a dealer terminal of the progressive poker jackpot system.

FIG. 5B-5D are views of a dealer terminal screen according to one embodiment of a dealer terminal of the progressive poker jackpot system.

FIG. 6 is a perspective view of an embodiment of a display assembly of the progressive poker jackpot system.

FIG. 7 is a block diagram of an embodiment illustrating a number of components that are in communication with each other within the progressive poker jackpot system.

FIG. 8 is a block diagram of an embodiment of a gaming table control system of the progressive poker jackpot system.

FIG. 9 is a diagram of a progressive poker jackpot network that includes a plurality of gaming establishments linked to a central computer system.

### DETAILED DESCRIPTION

Embodiments of the present invention relate to progressive jackpot gaming systems, and particularly to progressive poker jackpot systems.

Embodiments of the various aspects of the invention are discussed below with reference to the drawings. However, those skilled in the art will appreciate that the description provided herein with respect to these figures is for explanatory purposes as the invention extends beyond these limited embodiments.

As noted above, embodiments of the present invention relate to progressive gaming systems, particularly, to progressive poker jackpots that can be generated, maintained, and distributed by such systems. In one embodiment, a progressive poker system may include a plurality of electronic betting stations that are identified to participate in a progressive poker jackpot. As described in more detail below, the betting stations may be located on a number of gaming tables throughout different gaming establishments in a large area such as a city, county, or a state. Players can place wagers via the betting stations on a progressive poker jackpot and lesser prizes that gives the players a chance to win an award that is not related to that player winning, losing, or tying the particular hand in the underlying poker game. As will be appreciated, if a jackpot hand or a lesser prize does not hit during the poker hand, a certain amount of the wager will be added to the progressive jackpot and a certain amount of the wager may be added to a reserve fund.

In one embodiment, the betting stations may be coupled to a central computer that links the betting stations together in electronic communication and allows the central computer to accept or deny certain betting stations from participating in the progressive poker jackpot game and to monitor such betting stations and receive and provide information thereto. The progressive poker game provides a player the opportunity to play the underlying poker game that is being conducted at a table, such as hold 'em poker, and also allows the option for the player to participate to win a progressive poker jackpot, for example, a wide area progressive poker jackpot.

In one embodiment, the central computer stores information relating to the progressive poker jackpot, e.g., a base prize amount, if any, a percentage of contribution from each wager used to increase the prize amount, a percentage used to add to a reserve amount, if any, and similar information. In one embodiment, the central computer may request information from local controllers which can provide information about the amount of wagering contribution towards the progressive poker jackpot for all of the electronic betting stations that are participating in the progressive poker jackpot and which are coupled to that local controller.

In one embodiment, the central computer may calculate each incremental prize and each incremental reserve amount and send such information to the local controllers for communicating and/or displaying the prize amount to players. The local controllers may also provide information to the central computer when a player at a particular electronic betting station has won a progressive poker jackpot or lesser prize.

If a player wins a progressive poker jackpot, the central computer may contact each local controller to obtain all possible wagers to be included in the progressive poker jackpot hit and may coordinate the progressive poker jackpot to reset either to zero or to a predetermined amount so that another progressive poker jackpot can be generated.

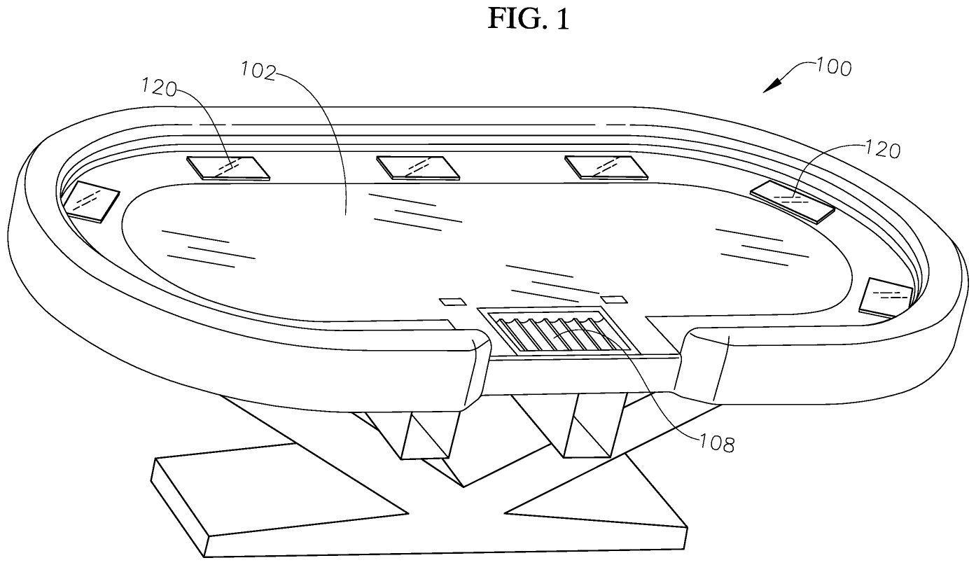

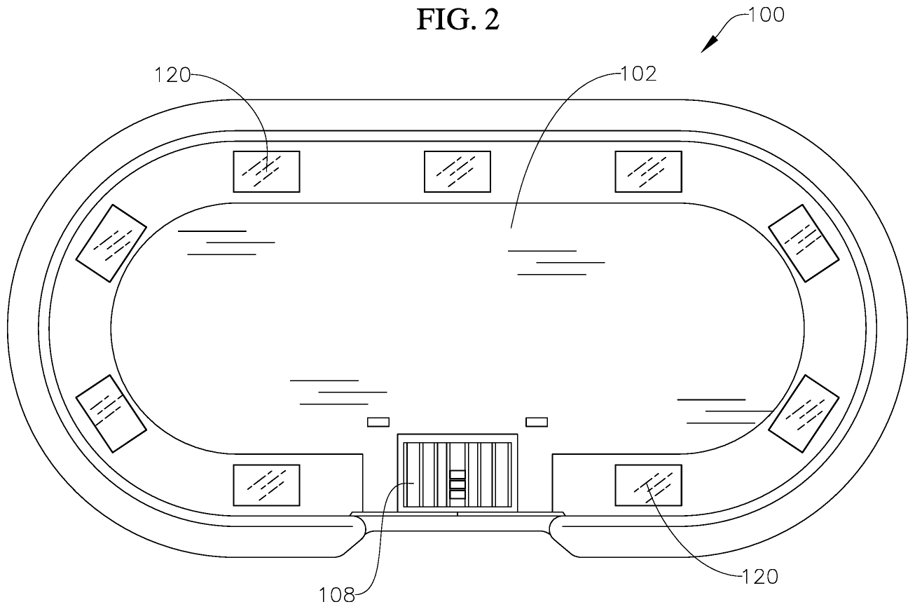

With general reference to FIGS. 1-6, embodiments of the progressive poker jackpot system 10 will now be described. FIGS. 1-3 illustrate views of a gaming table for a progressive poker jackpot system 10 according to one embodiment. However, more generally, it will be appreciated that the progressive poker jackpot system 10 may include any gaming apparatus that supports a game of chance, such as a wager-based game or a skill-based game, or some combination thereof. Examples of such gaming apparatus include gaming tables, electronic gaming devices, a computer, or any other electronic device capable of supporting a game.

With reference to FIGS. 1-3, the gaming table 100 has a table top surface 102 that supports various player positions around the table. The gaming table 100 can include an electronic card shoe 106, a chip tray 108, a dealer terminal 110, a display device 112, an edge display 114, and at least one betting station 120, as will be described in more detail below.

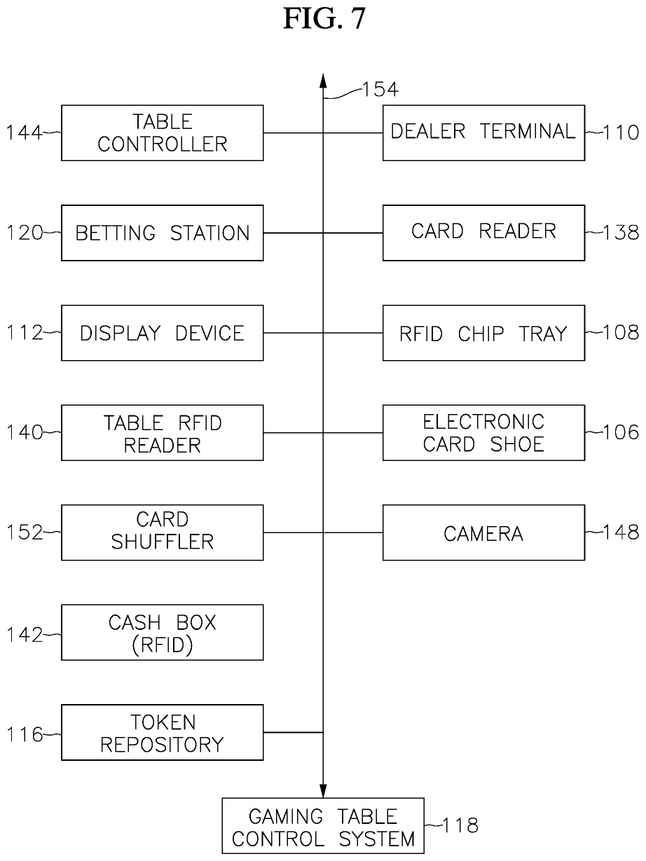

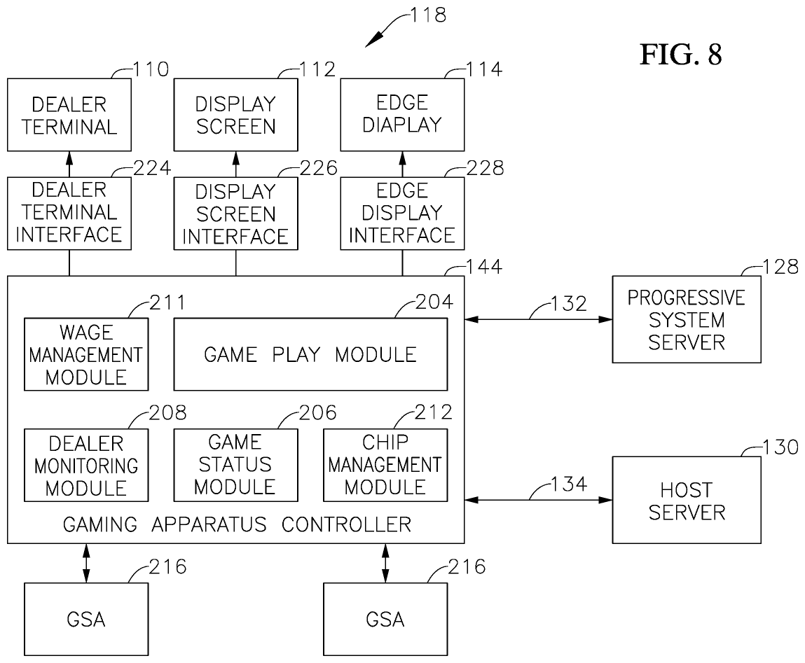

The gaming table 100 can also include a gaming table control system 118 that controls electronic operations at the gaming table 100. In one embodiment, the gaming table control system 118 is an electronic apparatus that can be programmed to provide various functions relating to management and operation of the progressive poker jackpot system 10. Particularly as described in more detail below with respect to FIGS. 7 and 8, in one embodiment, the gaming table control system 118 includes a gaming table controller 144 that controls overall operation at the gaming table with which the gaming table control system 118 is associated. The gaming table controller 144 is an electronic device that can include various functional components, such as modules, that are used by the gaming table control system 118 to perform various operations. Accordingly, the gaming table 100 can be referred to as an electronic gaming table because it makes use of a gaming table as well as various electronic devices to operate in connection with other gaming tables and with the progressive poker jackpot system 10.

The gaming table 100 is configured to support play of a game of chance, such as a card game that uses a plurality of cards, wherein players located around the table can receive cards specific to their hand and where they can all view the community cards which are turned face-up on the table surface 104 during game play. The gaming table 100 can generally accommodate gaming supplies in providing games of chance. The gaming supplies can include various supplies that might be available for use at the gaming table 100 to support a game of chance, such as cash, cards, tokens, chips, a dealer button, and the like.

The gaming table control system 118 can provide electronic monitoring and management of the game being played at the gaming table 100, including documenting use and causing the display of gaming supply inventory, bets, and wins, and presenting and displaying information to interested persons, such as players, dealers, or managers, of gaming-related information and dealer-related information. In doing so, the gaming table control system 118 can include or be in electronic communication with various electrical devices, such as a controller, sensors, displays, touch screens, buttons, lights, cameras, display interfaces, network interfaces, and electronic support appliances (e.g., electronic shoe for cards, shuffler, card reader, chip tray, voucher printer, bill validator and the like).

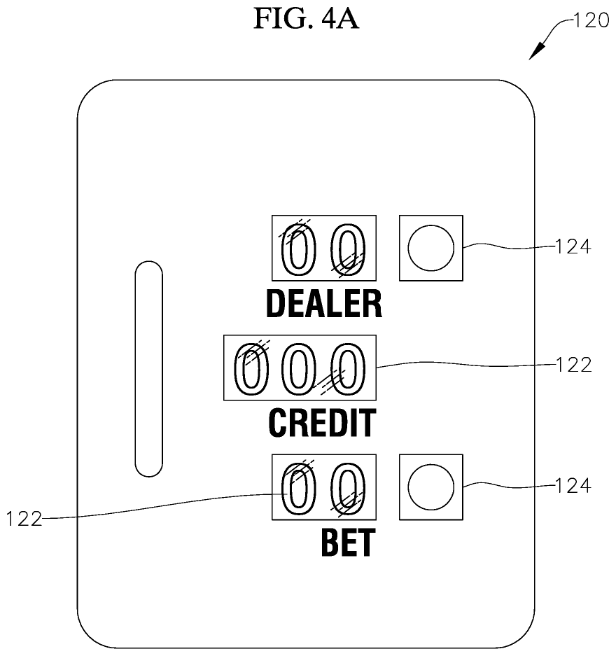

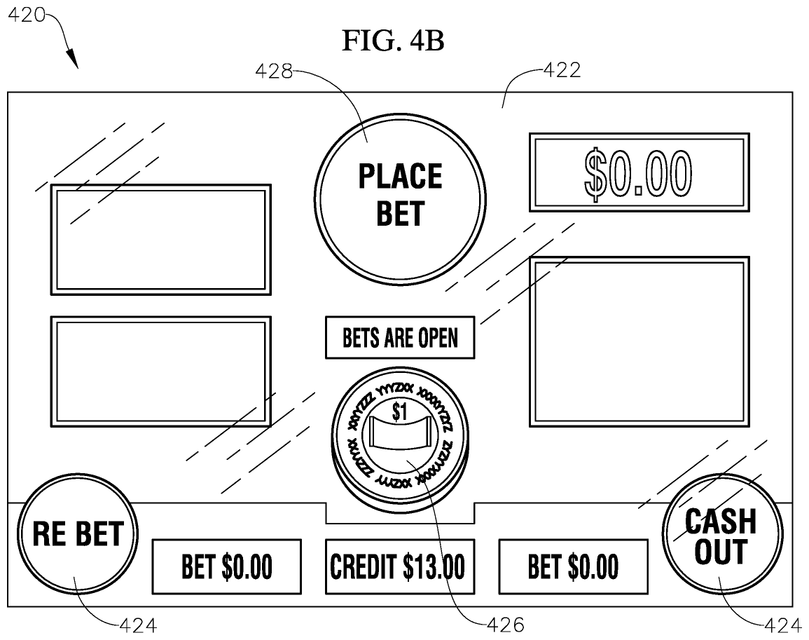

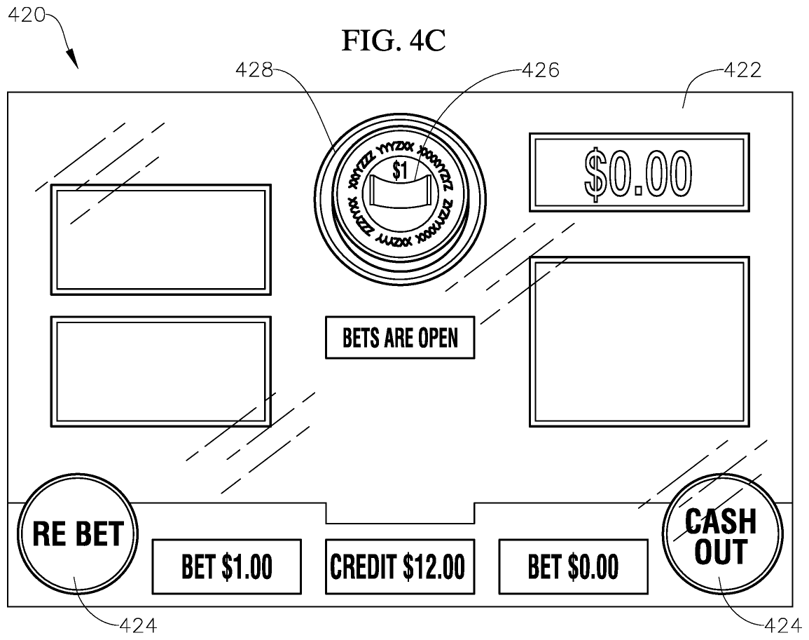

In one embodiment, with reference now also to FIG. 4A, the progressive poker jackpot system may include an electronic betting station 120 that is located on the gaming table 100. In one embodiment, the betting station 120 may be physically coupled to the gaming table 100, but it will be appreciated that the betting station may also be portable, handheld, and/or otherwise not physically coupled to the table. Each betting station 120 may include a display screen 122 or multiple display screens to display information to the user, including, for example, how many credits the user may have, whether the user is participating in the opportunity to win the progressive poker jackpot on this particular hand, the amount of the jackpot, among other information. In some cases, the betting station display screen 122 may be a touch screen that allows a player to enter their choices directly by touching the screen. For example, the display screen 122 may include a virtual button that allows a player to indicate their participation in the progressive poker jackpot as described below with respect to FIGS. 4B and 4C. In another embodiment, the betting station 120 may include a physical jackpot button 124 that allows a player to indicate their participation in the progressive poker jackpot.

In one embodiment, with reference to FIGS. 4B and 4C, a betting station 420 may include a touch screen 422 that displays various information and also allows players to provide input by pressing virtual buttons 424 and by moving virtual chips 426 into a “Place Bet” area 428. For example, the screen may display that “Bets are open” which may allow a player to slide virtual chip 426 over the “Place Bet” designated area 428 to indicate that the player would like to wager on the progressive poker jackpot game. The touch screen 422 may also display, for example, the player's account value and the jackpot value.

As described above, each participating betting station 120 is in electronic communication with a central computer 202 so when a credit for the progressive poker jackpot is wagered via the betting station 120, such wager may be communicated to the central computer. The central computer will then calculate how much of that wager will go to the primary jackpot prize and how much, if any, will go to a reserve fund and the central computer 202 can update the amount for both funds accordingly.

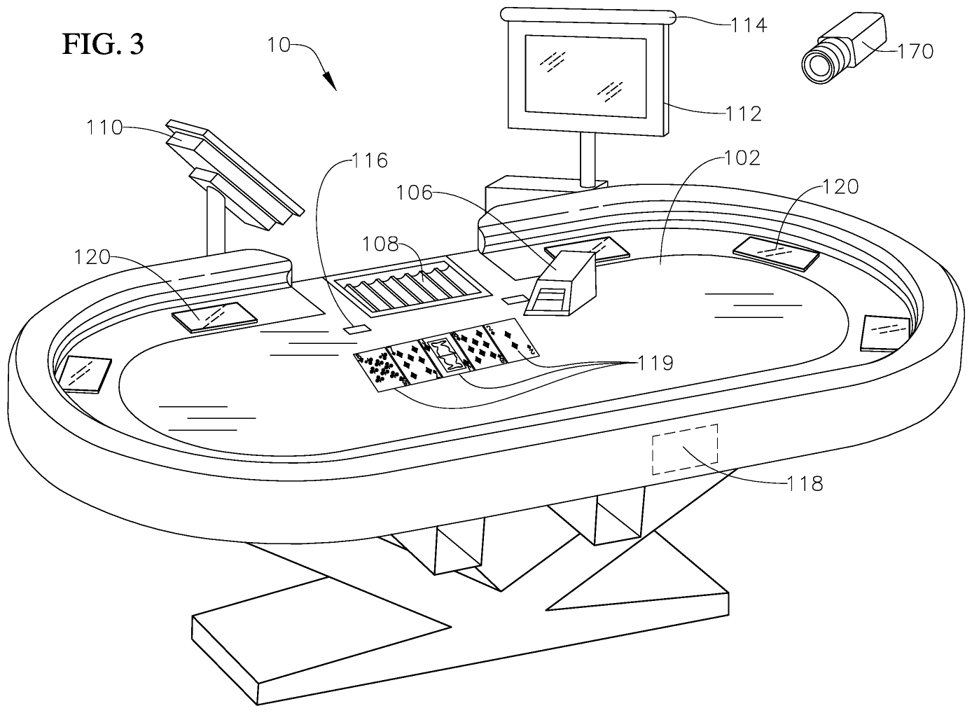

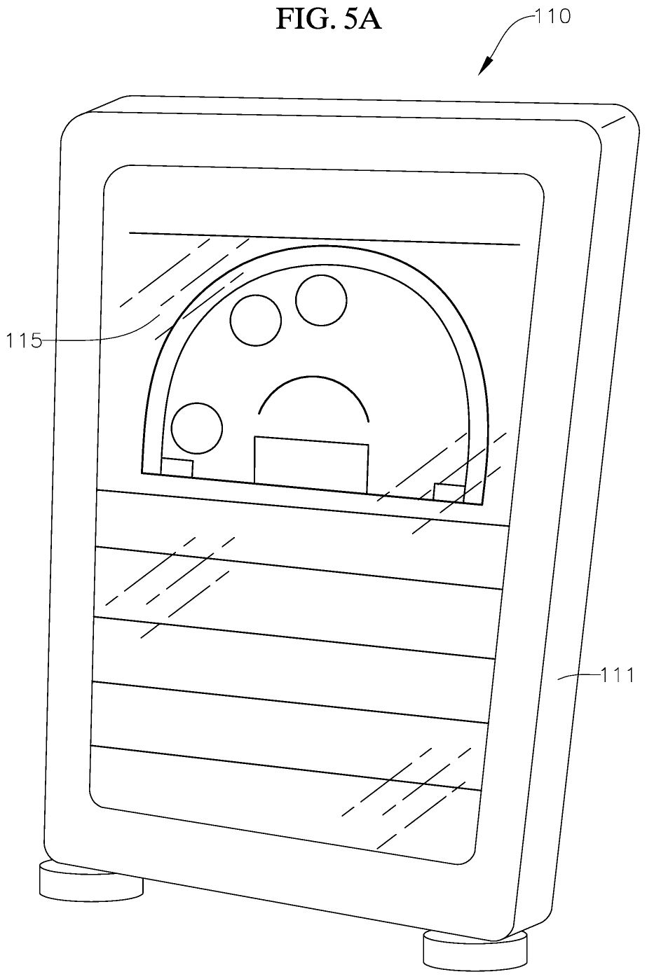

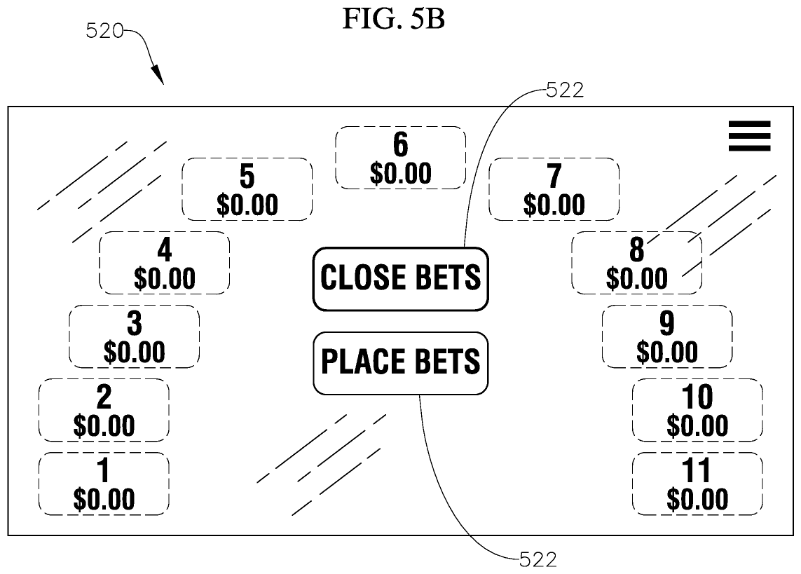

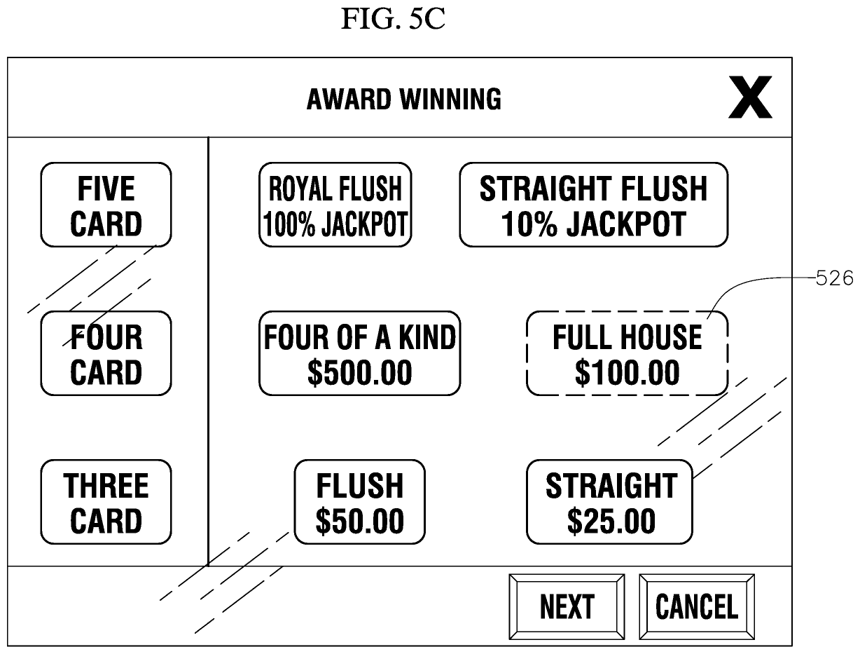

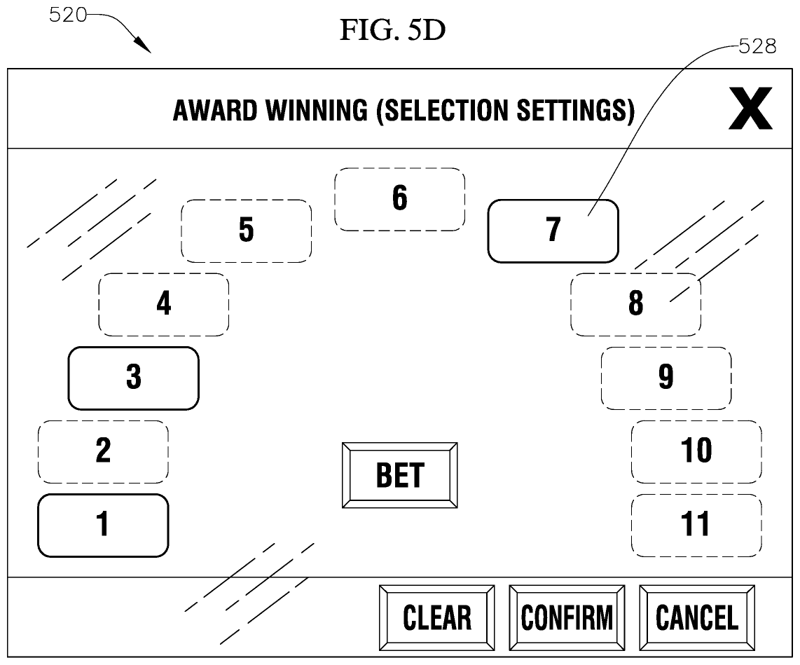

In one embodiment, the progressive poker jackpot system may also include a dealer terminal 110 as shown in FIGS. 3 and 5A. As described in more detail below, the dealer terminal 110 in configured to receive information from various components and to display such information to the dealer operating the gaming table. In one embodiment, the dealer terminal may include a housing 111 and a dealer terminal screen 115 on which the dealer may view the information display and which the dealer may use to input information to the system.

For example, with reference to FIGS. 5B-5D, the terminal screen 520 may provide virtual buttons 522 to allow the dealer to permit players to “Place Bets” on the jackpot system and then to cut off the ability to place bets by tapping on the “Close Bets” button. Further, the terminal screen 520 may allow the dealer to choose a virtual button 526 to indicate how many cards may make up a winning hand and a virtual button to choose which winning hand was made. Additionally, the terminal screen 520 may provide virtual buttons 528 to allow a dealer to select which players around the gaming table 100 should receive an award if a winning hand is made.

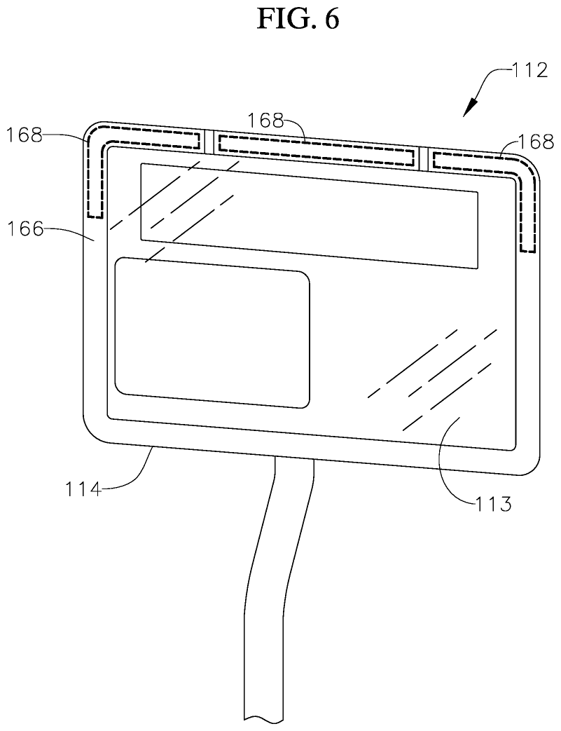

With reference also to FIG. 6, the gaming table control system 118 may also include at least one display device 112 to present information to interested persons and to any person within view distance. For example, the display device 112 can include an apparatus display screen 113 that can present information pertaining to game currently being played or having previously been played at the gaming table 100, including near-term historical information, player messaging, jackpot-related information, and other similar information. In one embodiment, the display device 112 can provide notification or messages to players with text, images or colored lighting relating to gaming information for a game being played at the table. In one embodiment, the display device 112 includes an edge display 114 which can present a message with light sources that offer substantially greater intensity that light provided by the apparatus display screen. In one embodiment, a message conveyed by the edge display 114 is able to be seen and understood from a significant distance away (e.g., 20-120 feet), whereas the information presented by the apparatus display screen 113 is configured for nearby persons (e.g., less than 15 feet). For example, the gaming table control system 118 may receive updates of the progressive poker jackpot amount from the progressive system server 128 and may communicate such amounts to the display device 112. which can then display the information for players, gaming establishment personnel, and by-standers to observe.

In one embodiment, the edge display 114 includes an outer cover structure 166 that can be positioned around at least a portion of an outer periphery of the display screen 113. The outer cover structure 166 can include a plurality of light segments 168 located within the outer cover structure 166. Particularly, in one embodiment, the outer cover structure 166 has a central hollow region that can contain the plurality of light segments 168. The outer cover structure 166 is configured to allow light to at least partially pass through the structure. That is, when one or more of the light segments are individually controlled by the gaming table control system 118 to be illuminated, the resulting light is able to at least partially pass through the outer cover structure 166, either through the outer cover material or by way of openings. As shown in FIG. 6, the outer cover structure 166 is provided around an entire periphery of the display screen 113. However it will be appreciated that the outer cover structure 166 extend around only a portion of the display screen 113.

In one embodiment, with reference again to FIG. 3, the gaming table 100 can also include a camera 170 that can be used for a number of purposes including security and card detection. Such camera 170 can be controlled to capture one or more images or a short video clip of a token being dropped into the token repository apparatus 116. The images or video clip can be time stamped and stored for auditing purposes. In another embodiment, the camera 170 or another image capture device can be used to capture images of the face up cards on the table which can then be used to determine whether a player should be awarded the progressive poker jackpot or a lesser prize. In one embodiment, the image data captured by the camera 170 could be automatically recognized by the gaming table control system 118 as either a winning hand or not a winning hand. When the gaming table control system 118 recognizes a winning hand, it may automatically take any number of actions including informing the dealer on the dealer terminal 110 of the winning hand, automatically funding any player who won a reward with the winning hand, and automatically updating the jackpot amount based on any funds paid out to players.

As noted above and with reference also to FIG. 7, the gaming table 100 may include the electronic card shoe 106 and a chip tray 108 which may be an RFID chip tray. The electronic card shoe 106 is configured to contain and allow the release cards that are used in playing a wager-based card game at the gaming table 100. In one embodiment, the electronic card shoe 106 may include a locking function that can prevent cards from being removed (i.e., dealt), so as to control when the cards can be removed from the electronic card shoe 106. For example, the electronic card shoe 106 can be placed in a locked condition in which unauthorized users are unable to make use of cards from the electronic card shoe 106. In one embodiment, the electronic card shoe 106 can include a card reader 138. The card reader 138 is able to optically read the cards being removed (i.e., dealt) from the electronic card shoe 106. The data captured by the card reader 138 can be provided to the table controller 144 for monitoring of the distribution of cards from the electronic card shoe 106 in conjunction with playing of the wager-based card games at the gaming table 100. The RFID chip tray 136 is one implementation of an electronic chip tray that can electronically monitor quantities of chips, markers, money, tokens, and the like within the electronic chip tray. The RFID chip tray 136 can also be coupled to the table controller 144. In one embodiment, the RFID chip tray 136 can be covered and/or locked to inhibit access to the items within the electronic chip tray, such as during lockdown of the gaming table 100.

The gaming table 100 can further include the table RFID reader 140. The table RFID reader 140 can be provided at the gaming table 100, which can include a gaming table. The table RFID reader 140 can utilize short range radio signals to monitor game play and/or gaming supplies at the gaming table 100. The table RFID reader 140 can include or interact with the RFID chip tray 136.

The gaming table 100 can include a cash box 142 that can receive and store cash. In one embodiment, the cash box 142 can be a RFID cash box. The cash box 142 can include a lockout function to prevent utilization of the cash box 142 by unauthorized users or unauthorized times. The cash box 142 can be controlled by the table controller 144.

In one embodiment, an electronic card shuffler 152 may be connected to the gaming control system 118 and may serve to randomize the cards that will be used to player the underlying poker game as well as the progressive poker jackpot game.

The progressive poker jackpot may be generated by eligible players supplying credits to build the progressive poker jackpot while having an opportunity to win the jackpot. As described in more detail below, players may add credits to the jackpot via a device, such as a betting station 120.

FIG. 8 is a block diagram of a gaming table control system 118 according to one embodiment. With reference to FIGS. 7 and 8, the betting station 120 may be in electronic communication with a progressive system server 128 via the table gaming control system 118 which may be used to provide progressive poker jackpot services to the gaming table 110. The progressive poker jackpot services enabled by the progressive system server 128 increase the game playing capabilities of a gaming by enabling a larger jackpot which results from player contributions from a significantly larger number of tables than would be possible if only one or a few gaming tables were participating in the jackpot by linking a number of gaming tables 100 together even when the tables are not in the same room or even the same gaming establishment. Participating in a poker game at the gaming table 100 allows a player a chance to play and win the large progressive poker jackpot. The rate at which the jackpot grows increases as the number of gaming tables connected to a progressive poker system server, and thereby the number of players, is increased. Accordingly, the larger the size of the jackpot, the more likely players may sit down at the gaming table 100 to try to win the jackpot.

In one embodiment, electronic gaming tables 100 may be added or removed from participating in the progressive poker jackpot. Particularly, any number of particular gaming tables 100 may establish a connection with or disconnect from the progressive system server to indicate whether or not that table is participating in the progressive poker jackpot. In order to initiate participation by a gaming table 100 in the progressive poker jackpot, the gaming table 100 via the gaming control system may send a message with a request for the table to join the progressive system server 128. The progressive system server 128 may then execute an authentication process to verify the identity of the gaming table that is attempting to participate in the progressive poker jackpot game. In one embodiment, the progressive system server 128 may include a list of gaming tables and associated identification information for each gaming table that is allowed to join in the progressive poker jackpot game. The gaming table 100 and the progressive system server 128 may exchange information that may be used to allow the progressive system server to accept the gaming table 100 into the progressive poker jackpot game. For example, if the progressive system server 128 can verify the gaming table 100 information, the progressive system server 128 may then allow the gaming table 100 to log into a progressive network 154 and to thereby allow a player playing on the gaming table to participate to win the wide area progressive poker jackpot. On the other hand, if the progressive system server 128 cannot authenticate the information from the gaming table 100, then the progressive system server 128 may prevent the gaming table from being able to participate for an opportunity to win the progressive poker jackpot.

Once gaming table 100 has been accepted by the progressive system server 128, then the progressive system server may add the gaming table to a list of devices that the progressive system server requests contributions to the wide area progressive poker jackpot and the gaming table 100 may be denoted as eligible to win the wide area progressive poker jackpot. Then, the progressive system server 128 may start requesting from the gaming table 100 information regarding contributions to the progressive poker jackpot. If, for some reason, the gaming table 100 is not allowed to join the progressive poker jackpot game, then the progressive system server 128 may notify the gaming table 100 that it is not eligible to join the progressive poker jackpot game. After the gaming table 100 receives this message, players at the table may be notified that this table is not available for the wide area progressive poker jackpot. In one embodiment, the display device 112 may be used to covey to players at the gaming table 100 that they are not eligible to wager on the progressive poker jackpot.

In one embodiment, the progressive system server 128 may provide information to identify itself to the gaming table 100 in its request for information and ask for the gaming table's status as well as any contributions to the progressive poker jackpot provided by the progressive system server. The gaming table 100 may compare the information from the progressive system server 128 with its current configuration to determine what information to report to the progressive system server. For example, after receiving a request from the progressive system server, the gaming table 100 may notify the progressive system server of its status, such that it is currently configured to allow participation in the progressive poker jackpot support by the progressive system server, an amount of that table's contribution to the wide area progressive poker jackpot, and/or that it is idle. Thus, the progressive system server 128 may identify that gaming table 100 as eligible to participate in the first wide area progressive poker jackpot and continue to request from the gaming table 100 its status and contribution amount.

In another embodiment, after receiving a request from the progressive system server 128, the gaming table 100 may notify the progressive system server that it is not currently configured to allow participation in the progressive poker jackpot supported by the server. The progressive system server 128 may continue to request the gaming table 100 for its status. However, the server 128 may identify the gaming table as ineligible to win the progressive poker jackpot or any lesser awards until the server is informed of a change in the status of gaming table 100 that indicates it is currently configured to contribute to progressive poker awards maintained by the server 128.

In yet another embodiment, a requesting procedure does not have to be used by the progressive system server 128. For example, each time a switch is triggered that allows the gaming table 100 to participate in the progressive poker jackpot game, the gaming table may notify the progressive system server 128 supporting the progressive poker game of its status. The progressive system server 128 may send a reply message to the gaming table 100 confirming its status. Then, each time the gaming table 100 determines that it has a contribution to make to the progressive poker jackpot, and in particular, to the wide area progressive poker jackpot, the gaming table may inform the progressive system server 128 and provide the information.

With continued reference now to FIG. 8, a particular gaming entity may desire to provide network gaming services that provide some operational advantage. Thus, each of the gaming tables 100 may be connected to a host server 130 via the gaming table control system 118 to track the performance of gaming tables under the control of the entity, such as for accounting management, electronic fund transfers, cashless ticketing, marketing management, data tracking, and player tracking.

In one embodiment, various gaming tables 100 may be connected through multiple communication paths to a number of gaming-related devices that provide gaming-related services. In one embodiment, the gaming table 100 is connected to communication paths that connect the gaming table to various other components. For example, communication path 134 may connect the gaming table 100 to the host server 130 to send information thereto. The gaming table 100 may be connected via other communication paths to additional gaming-related devices that provide other gaming-related services.

In some embodiments, the gaming tables 100 may be connected to a central system and/or other gaming establishments via one or more networks 154 (FIG. 7), which may be public or private networks. For example, the host server 130 and/or the progressive system server 128 may be connected to an outside network. In other embodiments, a switch or another type of network device may be part of an interface with an outside network. A network device that links a gaming establishment with another gaming establishment and/or a central system will sometimes be referred to herein as a “site controller.”

Additionally, the gaming table 100 may be electronically linked via the gaming table control system to outside servers, such as the progressive system server 128, the host server 130, as well other appropriate servers.

As illustrated in FIG. 8, the gaming table controller 144 can include a game play module 204, a game status module 206, and a dealer monitoring module 208. The game play module 204 can, for example, manage game play at the gaming table associated with the gaming table control system 118. The game status module 206 can monitor status of one or more wager-based games being played at the gaming table. For example, the game status module 206 could monitor the game state of a wager-based game, gaming supplies, player stats, dealt cards, winners, winning streaks, and the like.

The dealer monitoring module 208 can, for example, monitor dealer status. In one embodiment, the gaming table 100 supports the play of one or more wager-based games that are operated by a dealer resident at the gaming table (a so called “live dealer”). Hence, the dealer monitoring module 208 can additionally or alternatively serve to monitor the status of the dealer, such as dealer performance, dealer breaks, dealer requests, dealer shift changes, and the like.

The gaming table controller 144 can also include a wager management module 211. The wager management module 211 can assist a dealer and/or player with placing wagers (bets) at the gaming table. For example, the wager management module 211 can coordinate play of wager-based games by various players, facilitate receipt and confirmation of wagers by players, facilitate confirmation and acceptance of wagers by a dealer, and/or monitor performance of such wagers. The wagers being placed can be for a primary game at the gaming table, a side bet at the gaming table, or even an auxiliary bet on a wager-based game operating on another gaming table.

The gaming table controller 144 can also include a chip management module 212. The chip management module 212 can interact with a token repository apparatus, such as the token repository apparatus 116, to control, manage and/or monitor tokens being deposited into the token repository apparatus 116. That is, the chip management module 212 can assist the processing capabilities of the token repository apparatus 116 or can operate the token repository apparatus 116 as a peripheral device.

The gaming table controller 144 can support the token repository apparatus 116 shown in FIG. 3. In one embodiment, the token repository apparatus is an electro-mechanical device that can be used to receive tokens (e.g., chips) from a user (e.g., dealer, player, etc.). The tokens being received can be analyzed to determine their value (i.e., monetary value) and/or their validity (e.g., mitigate fraud). In one embodiment, the token repository apparatus 116 can include one or more electronic sensors that serve to capture data that can be evaluated to make a determination of the value and/or authenticity of the token(s). For example, the electronic sensors can include one or more of a weight sensor (e.g., electronic scale), a diameter sensor, a proximity sensor, and an image sensor (e.g., camera). In some embodiments, the token repository apparatus can also include a notification component, such as a display or illumination elements, to provide notifications (e.g., illumination of graphics and/or text) to a player or dealer.

The gaming table controller 144 can also be coupled to the progressive system server 128 via a network link 132. The network link 132 can represent one or more networks and/or one or more network links, whether wired or wireless.

The gaming table controller 144 can also be assisted by one or more gaming support appliances 216. The gaming support appliances 216 can couple to the gaming table controller 144 by either wired or wireless accommodations. Examples of gaming support appliances 216 include those also described with respect to FIG. 7, for example including an electronic shoe, an electronic lock, an electronic chip tray, a token repository apparatus, electronic betting assistants, voucher printer, electronic card shuffler, and the like. As shown in FIG. 8, the gaming table control system 118 includes gaming support appliance 216a and gaming support appliance 216b.

In one embodiment, the gaming table control system 118 can further include a dealer terminal interface 224, a display screen interface 226 and an edge display interface 228. The dealer terminal interface 224 provides an interface to the dealer terminal 110. The display screen interface 226 provides an interface to the display screen 112. The edge display interface 228 provides an interface to the edge display 114. These interfaces can facilitate control over what information is presented on the various display devices. The interfaces can, for example, include controllers, drivers, memory, and the like. Although the various interfaces and display screens are shown separately, in other embodiments it is possible that one or more of these interfaces and/or displays can be integrated together, shared or provided adjacent one another.’

As noted above, players at any one of a number of gaming tables 100 may participate in the opportunity to win a progressive poker jackpot. In one embodiment, the progressive poker jackpot may be a wide area progressive poker jackpot that typically involves a large jackpot prize that has a low probability of being won. The progressive poker jackpot scheme may include a paytable, denomination, entry fee, and software.

In one embodiment, players may be seated around one of a plurality of gaming tables 100 wherein the gaming tables are configured to allow participation by the players in an underlying poker game as well as in a progressive poker jackpot. As will be appreciated, the plurality of gaming tables 100 may all be in the same room, may all be on the same property, or may be on different properties in a single jurisdiction such as the same city, county, state, or country. Additionally, players may be playing the game on an electronic device such as a laptop or a mobile device and therefore may be located at a virtual table that is also configured to allow participation in the progressive poker jackpot. In one embodiment, the gaming table 100 may be configured to allow participation in the progressive poker jackpot by players playing any one of a variation of poker such as hold 'em, stud, draw, and others. While all of the players seated at each table may be participating in the underlying poker game at that table, not all of the players, or perhaps even none of the players at a particular table, may be participating in an opportunity to win the progressive poker jackpot. As such, it will be appreciated that the progressive poker jackpot opportunity is optional for those who want it, but otherwise, players can merely play the poker game being played at the table. As will be appreciated, players can choose on a hand-by-hand basis whether they want to participate in an opportunity to win the jackpot or a lesser prize in that hand.

In order to participate in the progressive poker jackpot, in one embodiment, a player may place a jackpot fee on the community cards that will ultimately be turned face up on the table and may be shared by the players at one table to make their regular poker hands. In one embodiment, the amount of the jackpot fee may be a fixed and constant amount, but it will be appreciated that the jackpot fee may also be a range of amounts, wherein the player can decide how much to wager.

In order to place the jackpot fee, a player may use an electronic betting station 120 that is located on the gaming table 100. Before being able to place a jackpot fee, the player may have to “pre-load” their betting account such that their betting station 120 reflects that the player has enough cash or credits to be able to place the jackpot fee. If the player is eligible to participate in the progressive poker jackpot, that player may indicate their willingness to participate in the jackpot, for example, by pressing the jackpot button 124 on the betting station, by tapping on a similar virtual button on the display screen 122 of the betting station 120, or by moving a virtual chip 426 into a “Place Bet” area 428.

Once the time for entering wagers on the progressive poker jackpot has ended, the dealer may cut off the ability for players to enter a wager on the jackpot by pressing a “Close Bets” or similar button on the dealer terminal 110. Alternatively, the dealer may press a virtual “Close Bets” button 522 on the dealer terminal 110. In one embodiment, pressing the “Close Bets” button 522 will prevent any players from placing any more jackpot bets on the current hand by disabling the betting station button 124/522 on the betting stations 120 or removing or graying out the virtual button.

Then, the dealer may deal the poker hand and a determination may be made if any participating player has won the progressive poker jackpot or a lesser prize. As will be appreciated, there may only one hand that allows a player to win the wide area progressive jackpot, but there may be opportunities for players to winner a lesser prize for making a non-jackpot hand. For example, in order to win the jackpot hand, the rules may state that the board has to show a particular five card hand that is unlikely to occur often, such as a royal flush. Additionally, a lesser prize than the jackpot prize may be awarded if a player makes a hand that is lesser than the jackpot hand. For example, a player may win a lesser prize for making a five card straight flush that is not a royal flush or for making four of a kind, among other hands. Additionally, a player may win a lesser prize that is not the jackpot for making less than a five card hand, such as a four-card straight flush or even a three-card straight flush. In one embodiment, only the cards that are the “community cards” 119 that are turned face-up on the gaming table 100 may be used to win the jackpot hand or a lesser hand.

After the community cards 119 have been turned face up or otherwise exposed, it may be determined if a winning hand is present. As noted above, the winning hand may be determined by the dealer or may be determined automatically by the gaming table control system 118 via information from the camera 170 or another image capture device. If a winning hand is present, it may be determined if any of the players is due the jackpot or a lesser prize. Particularly, it may be determined whether any of the players were playing for the wide area progressive poker jackpot prize and/or one of the lesser prizes and, if applicable, whether there were enough players at the gaming table 100 who received dealt cards such that the gaming table qualified for the progressive poker jackpot and/or the lesser prizes for that particular hand. If it is determined that a player has won the wide area progressive poker jackpot, the dealer/gaming table 100 may notify the player of their win or they may be automatically notified on their betting station 120 by the gaming table control system 118. Further, the dealer/gaming table 100 may determine whether additional bonus credits have been won, if available.

In one embodiment, a player who entered the progressive poker jackpot game at an eligible table may be eligible for the jackpot prize and/or a lesser prize whether their hand in the underlying poker game wins, loses, or ties. Further, if there is more than one winner from the multiple linked tables qualifying for the progressive jackpot or a lesser prize, the winners may be paid an amount displayed on the display device 112 or elsewhere and may be paid in the order in which the wins occur. If for any particular reason, there are not enough funds to pay winners from the primary fund, winners may be paid from the reserve fund.

In embodiments, the wide area progressive poker jackpot game may specify a number of outcomes according to a payout schedule for the game, separate from the chance to win the jackpot, where additional credits are awarded. If additional credits are awarded, the player's betting station 120 may display that the player's current credit amount is updated and meter values are updated. In one embodiment, when additional credits are awarded, the credits may only be used to play the wide area progressive poker jackpot game. In other embodiments, the credits may be transferred for play of a non-progressive game (i.e., the credits may not be cashed out and may only be used for play of the non-progressive game). In yet another embodiment, when additionally credits are awarded, the credits may be cashed out of the gaming device for full face value or for a value less than face value of the credit.

In one embodiment, a player may choose to automatically participate in the wide area progressive poker jackpot as long as the player has enough credits to participate. As such, an embodiment is shown where any credits initially awarded to play the wide area progressive poker jackpot game or are awarded during the play of the progressive poker jackpot game are used to play the game as long as the available credits are greater than or equal to the max bet. When the available credits are greater than or equal to the max coin bet, the player automatically continues to play the wide area progressive poker game.

When the available credits are less than the max bet, the player is not automatically entered into the wide are progressive poker jackpot and they must add additional credits to their account before participating again. In one embodiment, if additional credits are added to a player's account, any unused credits may be cashed out and returned to the player.

In one embodiment, players located at one of the gaming tables 100 may engage in wagering against each other regarding an event that may occur. For example, a player may create a “side bet” or a “prop bet” that an ace will be one of the community cards that is turned over during play of the poker hand and the betting stations 120, the display device 112, or another device may display the posted odds relating to the side bet betting event. Other players around the table may then decide whether they would like to accept the odds and make a wager on the side bet event occurring. Accordingly, any player that would like to make a wager could use their betting station 120 to place a “side bet” on the proposed event occurring. If the event occurs, the gaming table control system 118 could be used to transfer funds from the side bet offerer's betting account to the winners of the side bet's betting account and if the event does not occur, the gaming table control system 118 could be used to transfer funds to the side bet offerer's account from those who accepted the bet. In one embodiment, the posted odds of the event occurring do not change regardless of how much action is wagered on either side of the side bet event. In another embodiment, the posted odds may change, for example, if there is a large amount of action on one side of the side bet betting event.

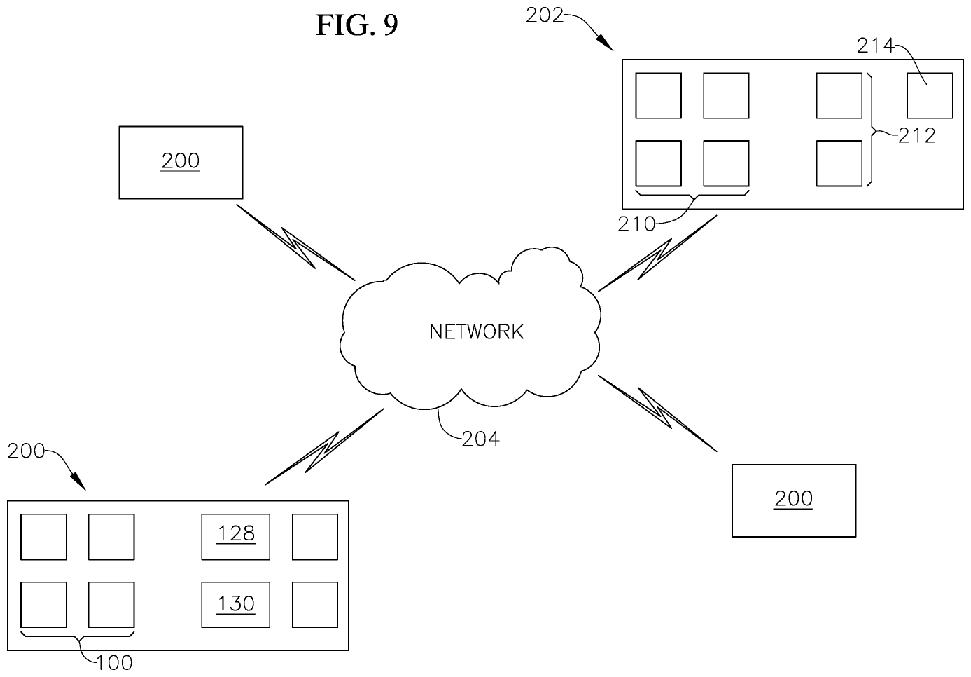

With reference now to FIG. 9 a schematic network diagram illustrates a plurality of gaming establishments 200 connected to a central computer 202 via a network 204. However, it will be appreciated that more or fewer gaming establishments may be in communication with the central computer 202. Moreover, although the central computer 202 is depicted as having a single location, it will be appreciated that the devices that constitute central computer may be in two or more locations.

In one embodiment, the gaming establishment 200 is a casino. However, it will be appreciated that the gaming establishment 200 could be any type of establishment that is configured to participate in bonusing and/or progressive poker jackpots, such as land-based casinos, Internet casinos, card rooms, and the like. Each gaming establishment 200 may have the same owner or different owners.

In one embodiment, the system uses the Internet as the network 204. However, it will be appreciated that the network 204 could be any one of various other types of networks, such as a satellite network, a wireless network, and the like. Accordingly, a variety of protocols may be used for communication on the network 204, such as Internet Protocol (“IP”), Fibre Channel (“FC”), and FC over IP (“FCIP”), among others.

As will be appreciated, gaming establishment 200 may include gaming tables 100, host server 130, progressive system server 128, and other servers that allow the jackpot system to operate.

With continued reference to FIG. 9, each gaming establishment 200 may include a network device 210 that acts as a site controller for interacting with central computer 202 to provide progressive services. In one embodiment, a progressive system server 128 is configured to act as a site controller for providing progressive poker jackpot services. As will be discussed in more detail below, many of the functions involved in providing these services can be provided by either the site controller or the central computer.

In one embodiment, the central computer 202 includes a number of network devices 210 and storage devices 212, although it will be appreciated that the number of device may be more or fewer than then number shown. Additionally included is a central progressive server 214 which controls a progressive poker jackpot system 10 for all participating gaming tables and gaming establishments.

Central computer 202 may provide additional services, including but not limited to prize services, gaming software services, cashless services, communication services, loyalty program services, and entertainment content services, among others. In some implementations, individual network devices may provide some or all of such services, whereas in other embodiments separate network devices, storage devices, and the like, may be dedicated to providing such services.

While this invention has been described with reference to exemplary embodiments thereof, it will be clear to those of ordinary skill in the art to which the invention pertains that various changes and modifications may be made to the described embodiments without departing from the spirit and technical area of the invention as defined in the appended claims and their equivalents. Thus, the scope of the inventive concept shall not be restricted or limited by the foregoing description, but be determined by the broadest reasonable interpretation of the following claims and their equivalents.

What is claimed is:

1. A system for determining and awarding a monetary reward comprising:
a plurality of electronic gaming tables, each gaming table being configured to be connected to a network and being configured to allow the playing of an underlying game, each gaming table having a gaming table control system;
a progressive system server electronically connected to each of the gaming tables, the progressive system server configured to maintain an amount of a balance of the monetary reward;
a plurality of betting stations connected to the gaming table control system, each of the betting stations configured to allow a player to draw funds from a betting account and to place a jackpot wager to participate in an opportunity to win the monetary reward based on funds in the betting account, wherein at least a portion of the jackpot wager is contributed to the monetary award, wherein the monetary reward is separate from any award that can be won in the underlying game, and wherein the gaming table control system is configured to communicate with the server to add at least a portion of the jackpot wager to the monetary award maintained by the progressive system server;
a plurality of playing cards each having a designated value, wherein the playing cards are configured to be used for the underlying game and wherein a plurality of the playing cards are configured to be placed on the gaming table such that the designated value of the playing card may be exposed and such that certain combinations of the designated values of the playing cards result in a winning hand that captures the monetary award; and
a dealer terminal connected to the gaming table control system, the dealer terminal being configured to communicate to the server that a winning hand has occurred, wherein the progressive system server is configured to communicate to the gaming table control system to add at least a portion of the monetary reward to a player's betting account when the player has placed a jackpot wager and when the dealer terminal communicates to the server that the winning hand has occurred.

2. The system of claim 1, wherein the gaming tables are located in at least two different gaming establishments.

3. The system of claim 1, wherein the dealer terminal is configured to allow a user to provide the ability to the player to participate in the opportunity to win the monetary reward and is configured to allow a user to prevent the player from participating in the opportunity to win the monetary reward.

4. The system of claim 1, wherein a plurality of betting stations are located on each gaming table and wherein each of the betting stations has a touch screen to allow a player to make the jackpot wager.

5. The system of claim 1, wherein a plurality of betting stations are located on each gaming table and wherein each of the betting stations has a button to allow a player to make the jackpot wager.

6. The system of claim 1, further comprising a display device connected to the gaming table control system, wherein the display device is configured to display the monetary reward amount and to update the amount of the monetary award as the amount of the monetary award changes.

7. The system of claim 1, wherein the progressive system server is configured to be able to identify the gaming tables and is configured to allow or deny access of each of the gaming tables to join the system.

8. The system of claim 1, wherein the gaming table control system comprises a gaming table controller, the gaming table controller comprising a dealer terminal interface to interface between the gaming table controller and the dealer terminal.

9. The system of claim 1, wherein for each jackpot wager placed, a certain amount of the jackpot wager is contributed to the monetary award and a certain amount of the jackpot wager is contributed to a reserve monetary that may be distributed when a balance of the monetary award is not enough to award players when a winning hand is made.

10. The system of claim 1, wherein when the dealer terminal communicates to the progressive system server that a winning hand has occurred, the progressive system server is configured to award the monetary reward to each player at the gaming table that has made a jackpot wager.

11. A method for determining and awarding a monetary reward comprising:
connecting a plurality of electronic gaming tables to a network such that an underlying game can be played at each of the gaming tables and such that game information from each table can be shared with the network, each gaming table having a gaming table control system configured to:
electronically connect the gaming table to a progressive system server, the progressive system server configured to maintain an amount of a balance of the monetary reward;
receive via one of a plurality of betting stations connected to the gaming table control system a player contribution to funds for a betting account and a jackpot wager from the player based on funds in the betting account to participate in an opportunity to win the monetary reward, wherein the monetary reward is separate from any award that can be won in the underlying game;
communicate with the server to add at least a portion of the jackpot wager to the monetary award maintained by the progressive system server;
receive via a dealer terminal input regarding a winning hand made by a plurality of playing cards having a designated value, such designated value being exposed on the gaming table; and
add at least a portion of the monetary reward to a player's betting account when the player has placed a jackpot wager and upon notification from the progressive system server that a winning hand has occurred.

12. The method of claim 11, wherein the gaming tables are located in at least two different gaming establishments.

13. The method of claim 11, wherein the dealer terminal is configured to allow a user to provide the ability to the player to participate in the opportunity to win the monetary reward and is configured to allow a user to prevent the player from participating in the opportunity to win the monetary reward.

14. The method of claim 11, wherein a plurality of betting stations are located on each gaming table and wherein each of the betting stations has a touch screen to allow a player to make the jackpot wager.

15. The method of claim 11, wherein a plurality of betting stations are located on each gaming table and wherein each of the betting stations has a button to allow a player to make the jackpot wager.

16. The method of claim 11, further comprising a display device connected to the gaming table control system, the method further comprising displaying the monetary reward amount on the display device and updating the amount of the monetary award displayed on the display device as the amount of the monetary award changes.

17. The method of claim 11, wherein the progressive system server is configured to be able to identify the gaming tables and is configured to allow or deny access of each of the gaming tables to join the system.

18. The method of claim 11, wherein the gaming table control system comprises a gaming table controller, the gaming table controller comprising a dealer terminal interface to interface between the gaming table controller and the dealer terminal.

19. The method of claim 11 further comprising, for each jackpot wager placed, contributing a certain amount of the jackpot wager to the monetary award and contributing a certain amount of the jackpot wager to a reserve monetary that may be distributed when a balance of the monetary award is not enough to award players when a winning hand is made.

20. The method of claim 11, wherein when the dealer terminal communicates to the progressive system server that a winning hand has occurred, the method further comprises the progressive system server awarding the monetary reward to each player at the gaming table that has made a jackpot wager.
